(19) United States
(12) Patent Application Publication
(10) Pub. No.: US 2008/0302585 A1
(43) Pub. Date: Dec. 11, 2008

(54) TRANSPORT SYSTEM

(75) Inventors: Thomas Perelli, Winchester, VA (US); Grant M. Mason, Winchester, VA (US)

Correspondence Address: MOORE & VAN ALLEN PLLC, P.O. BOX 13706, Research Triangle Park, NC, 27709, US

(73) Assignee: Rubbermaid Commercial Products LLC, Winchester, VA (US)

(21) Appl. No.: 12/135,724

(22) Filed: Jun. 9, 2008

Related U.S. Application Data
(60) Provisional application No. 60/942,534, filed on Jun. 7, 2007.

(51) Int. Cl. B62D 39/00; B62B 11/00

(52) U.S. Cl. 180/14.1; 280/33.991

(57) ABSTRACT

A transport system comprises a first cart comprising a first plurality of wheels and a first docking system. A second cart comprises a second plurality of wheels and a second docking system for releasably connecting to the first docking system such that at least one of the first plurality of wheels is axially aligned with at least one of the second plurality of wheels. The carts may comprise a two shelf cart, a platform truck, an accessory module or other type of cart. A method of using the transport system is also provided.

### CROSS REFERENCE TO RELATED APPLICATIONS

This application claims benefit of priority under 35 U.S.C. §119(e) to the filing date of to U.S. Provisional Application No. 60/942,534, as filed on Jun. 7, 2007, which is incorporated herein by reference in its entirety.

### FIELD OF THE INVENTION

The invention relates generally to a transport system and more particularly to a system for selectively coupling various similar or dissimilar carts to create a composite cart that increases the capacity and flexibility of the cart during use.

### BACKGROUND OF THE INVENTION

Various types of carts are known such as platform trucks, utility carts, two shelf carts or the like. Typically, each cart is designed for a particular purpose where that purpose can be relatively limited. As a result the end user must purchase and store multiple carts and/or use the cart in a manner for which it was not intended.

An improved material handling system is desired.

### SUMMARY OF THE INVENTION

A transport system comprises a first cart comprising a first plurality of wheels and a first docking system. A second cart comprises a second plurality of wheels and a second docking system for releasably connecting to the first docking system such that at least one of the first plurality of wheels is axially aligned with at least one of the second plurality of wheels. The carts may comprise a two shelf cart, a platform truck, an accessory module or other type of cart. A method of using the transport system is also provided.

### BRIEF DESCRIPTION OF THE DRAWINGS

FIG. 1 is a perspective view showing one embodiment of the cart of the invention in a decoupled state.

FIG. 2 is a perspective view showing the embodiment of the cart of FIG. 1 in a coupled state.

FIG. 3 is a bottom view showing the embodiment of the cart of FIG. 1 in an uncoupled state.

FIG. 4 is a bottom view showing the embodiment of the cart of FIG. 1 in a coupled state.

FIG. 5 is a perspective view showing the locking mechanism in an uncoupled state.

FIG. 6 is a perspective view showing the locking mechanism in a coupled state.

FIG. 7 is a perspective section view showing the locking mechanism a coupled state.

FIG. 8 is a perspective view showing another embodiment of the cart of the invention in a decoupled state.

FIG. 9 is a perspective view showing the embodiment of the cart of FIG. 8 in a coupled state.

FIG. 10 is a perspective view showing two types of carts of the invention in a coupled state.

FIG. 11 is a perspective view showing yet another embodiment of the cart of the invention in a decoupled state.

FIG. 12 is a perspective view of another embodiment of a cart of the invention coupled to a different type of cart.

FIGS. 13 through 15 are alternative embodiments of a cart of the invention.

FIG. 16 is a perspective view showing another embodiment of the cart of the invention in an uncoupled state.

FIG. 17 is a bottom view showing the embodiment of the cart of FIG. 16 in an uncoupled state.

FIG. 18 is a perspective view showing an alternate embodiment of the cart of the invention.

FIG. 19 is a partial section view showing the cart of FIG. 18.

FIG. 20 is a side view of two carts coupled together in a flexed state.

FIG. 21 is a detailed side view of the carts of FIG. 20.

FIG. 22 is a perspective view showing a motor module coupled to a cart.

FIGS. 23 through 25 show section views of an alternate embodiment of a locking mechanism.

FIG. 26 is a block diagram illustrating a method of operating the system of the invention.

FIGS. 27 through 30 show section views of an alternate embodiment of a locking mechanism.

### DETAILED DESCRIPTION OF EMBODIMENTS OF THE INVENTION

The figures illustrate a variety of different types of wheeled vehicles used for storing and/or transporting materials. Such vehicles are commonly used in maintenance activities, warehousing, trucking and shipping, housekeeping, hospitals and many other applications. Such vehicles may include platform trucks, shelved carts, dollies, storage carts having drawers and cabinets or the like. As used herein the term “cart” is intended to mean all such types of wheeled vehicles.

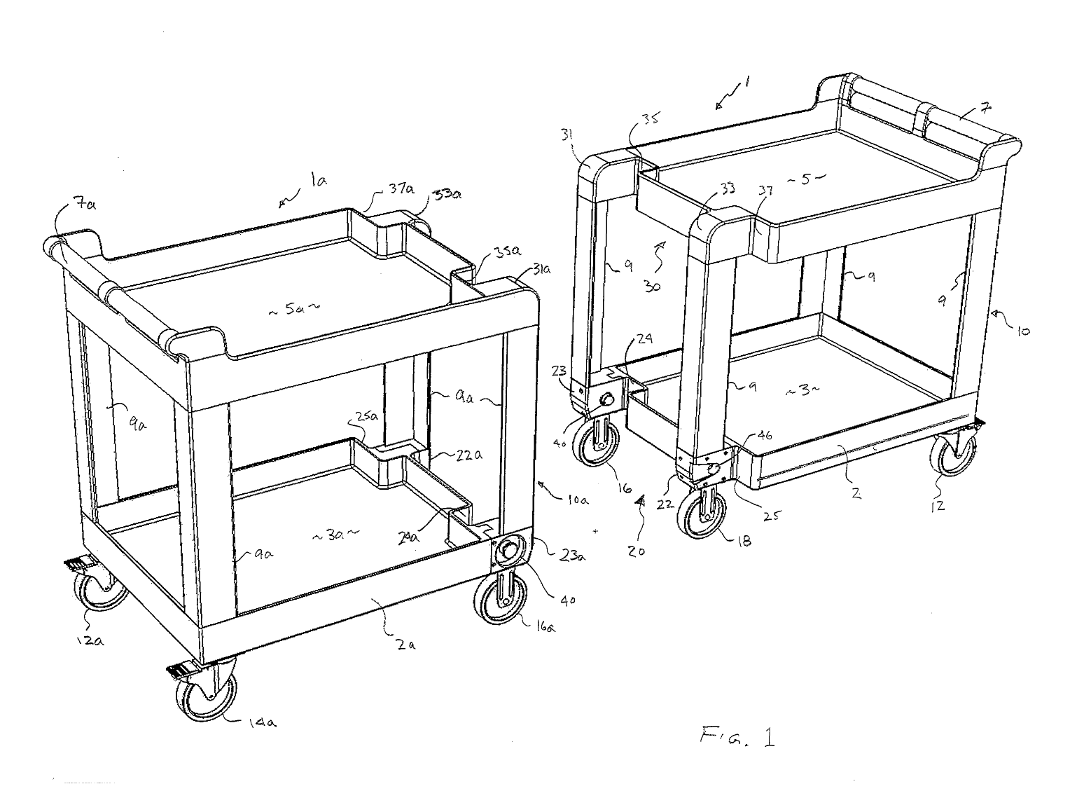

Referring to FIG. 1, an example cart 1 is shown that illustrates the operating principles of the cart of the invention. The cart 1 is a two shelf cart including a base 2 that forms a lower shelf 3 and that is supported on wheels such that it can be pushed, pulled or driven on a surface. Base 2 is a substantially rectangular structure, although the base 2 may be of any shape, and size. Extending from the base 2 is a superstructure 10 that may define shelves, handles for pushing or pulling the cart, cabinets, drawers or other storage structures. In the embodiment of FIG. 1 the superstructure 10 includes an upper shelf 5 connected to base 2 by uprights 9. A handle 7 is provided for pushing or pulling the cart 1. A second cart la is also shown where the components are designated by reference numerals with the postscript “a” to reference the same elements described with reference to cart 1.

Located at a first end of the base 2 is a pair of casters or swiveling wheels 12 and 14. The wheels 12 and 14 rotate about a first horizontal axis such that the wheels roll over the surface and rotate about a second vertical axis that is substantially perpendicular to the surface and to the base 2. Such wheels are referred to hereinafter as swivel wheels. While two swivel wheels 12 and 14 are shown, a greater or fewer number of wheels may be used. The swivel wheels 12 and 14 are selected and positioned to create a stable support for the cart.

Located on the second end of the base 2 opposite from wheels 12 and 14 are wheels 16 and 18. Wheels 16 and 18 rotate about a first horizontal axis such that the wheels roll over the surface but do not rotate or swivel relative to the cart 2 (the first axis is in a fixed position relative to the cart). Such wheels are referred to hereinafter as fixed wheels. The fixed wheel 16 is aligned with swivel wheel 14 along the length of the cart. The length of the cart as used herein refers to the direction the fixed wheels 16 and 18 roll. The other fixed wheel 18 is located off-line from swivel wheel 12 along the length of the cart 1. Fixed wheel 18 is located further toward the centerline of the cart 1 than swivel wheel 14 by at least the width of the wheel. The fixed wheels 16 and 18 are selected and positioned to create a stable support for the cart 1 such that the cart can roll on the wheels 12, 14, 16 and 18 without tipping.

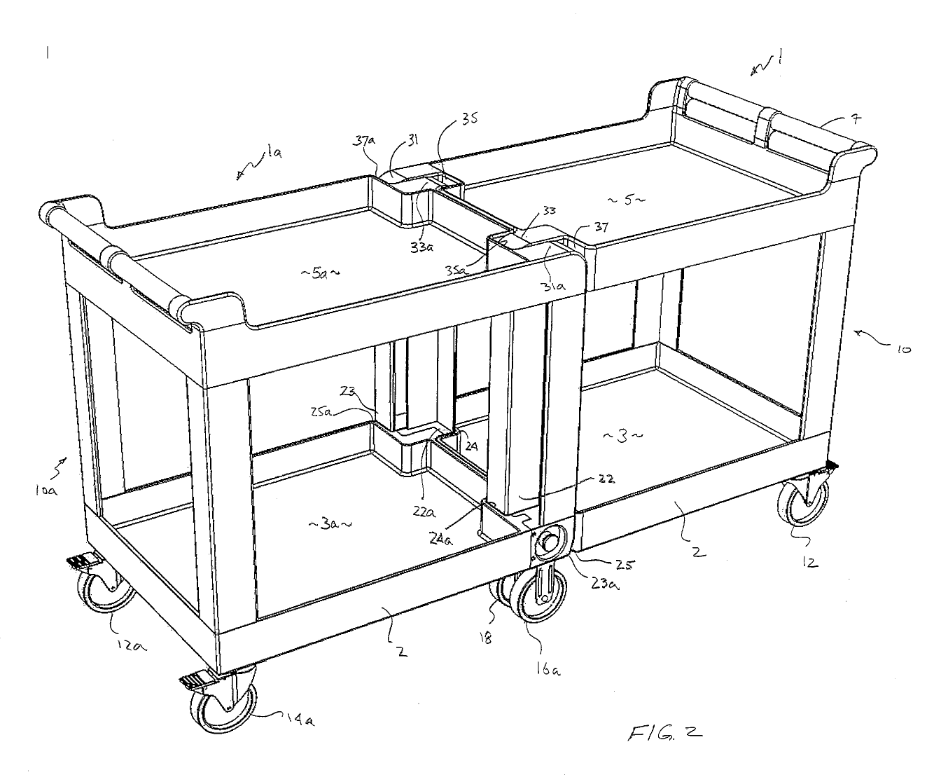

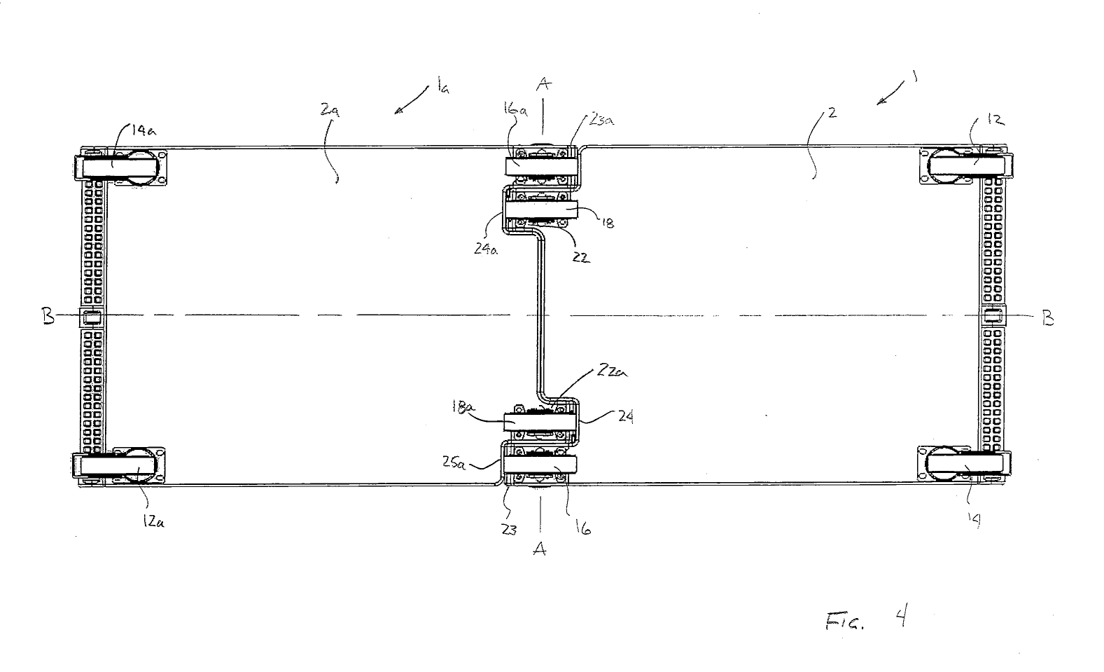

The cart 1 also includes a docking system 20 at the second end of the cart 1 that allows two carts to be joined together. The docking system 20 includes at least a first protuberance 22 and a first recess 24. The recess 24 and protuberance 22 are positioned on the cart 1 such that when the second end of a first cart 1 is positioned opposite the second end of a second cart la the protuberance 22 is aligned with the recess 24a such that the protuberance can be inserted into the recess to align and connect the carts together. The location of the fixed wheels 16 and 18 and the arrangement of the recesses and protuberances of the docking system 20 creates a cart that is asymmetrical around the center axis B-B. The fixed wheels 16 and 18 are positioned such that when the carts are connected together to create a composite cart, the axes of rotation of fixed wheels 16 and 18 on one cart are axially aligned on axis A-A with the axes of rotation of fixed wheels 16a and 18a on the second cart 1 a as best shown in FIGS. 2 and 4. Having the fixed wheels aligned with one another allows the composite connected carts to turn. This arrangement also allows the carts to fit together as closely as possible and minimizes the overall length of the carts when connected together

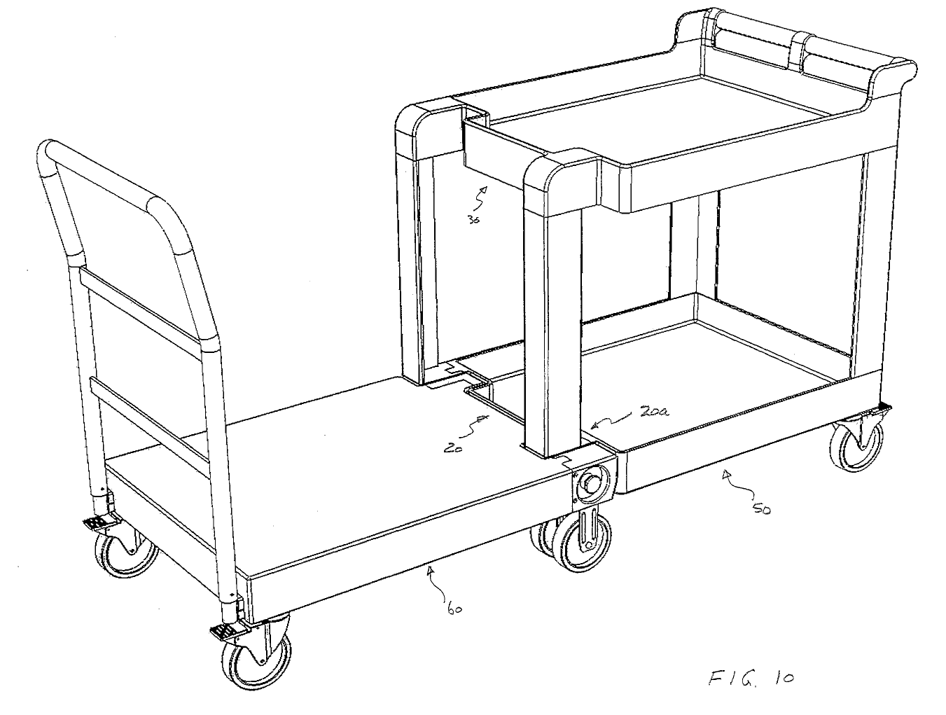

By using the asymmetrical design described above identical carts may be connected together as shown in FIG. 1. Even where the carts that are connected together are not identical, as shown for example in FIG. 10, the docking system 20 of the different carts may be identical.

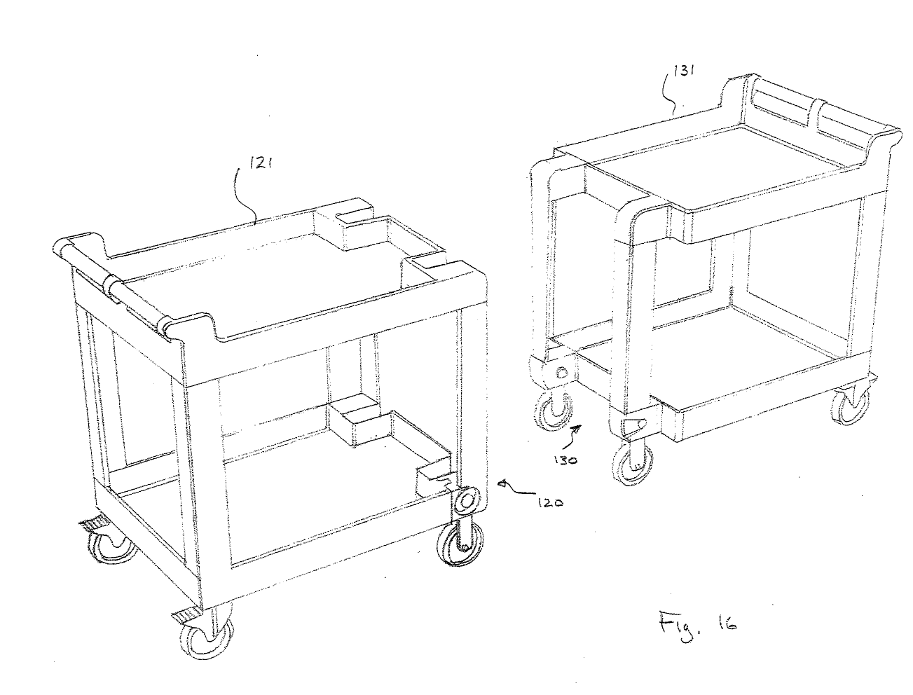

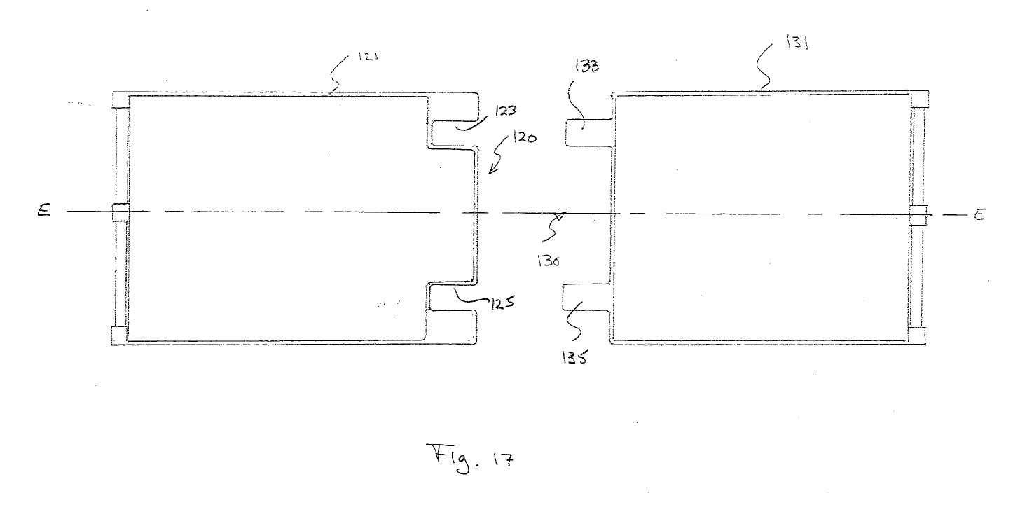

Referring to FIGS. 16 and 17 an alternate embodiment uses two different docking systems where a first cart 121 has a first docking system 120 that may be connected to a second cart 131 having a second docking system 130. The docking systems are symmetrical on each cart about the longitudinal axis E-E but the docking systems on each of the carts are different. Such an arrangement allows the axes of rotation of the fixed wheels to be located along a common axis as previously described but the carts are not identical. As illustrated in FIGS. 16 and 17, docking system 131 includes both of the protrusions 133 and 135 and docking system 120 includes both of the recesses 123 and 125.

In the illustrated embodiment the docking system 20 includes a second protuberance 23 and a second recess 25 where protuberance 23 of cart 1 mates with recess 25a of cart la and protuberance 23a of cart la mates with recess 25 of cart 1 to align and connect the carts together. The fixed wheels 16 and 18 are located on the protuberances 23 and 22, respectively, and fixed wheels 16a and 18a are located on protuberances 23a and 22a, respectively. When two carts are connected together, the protuberances and recesses interlock allowing the wheels to be axially aligned as shown in FIG. 4. While two sets of protrusions and recesses are shown on each cart, the system may include only a single recess and protuberance or additional mating sets of protrusions and recesses. In addition to the docking system 20 shown on the base 2, the illustrated cart includes a second upper docking system 30 located on superstructure 10. The second docking system 30 includes the interlocking protuberances 31 and 33 and recesses 35 and 37 similar to the protuberances and recesses described with respect to docking system 20. Protuberances 31 and 33 are inserted into recesses 35a and 37a and protuberances 31a and 33a are inserted into recesses 35 and 37. A single docking system may be used to connect the carts to one another or multiple docking systems may be used as shown.

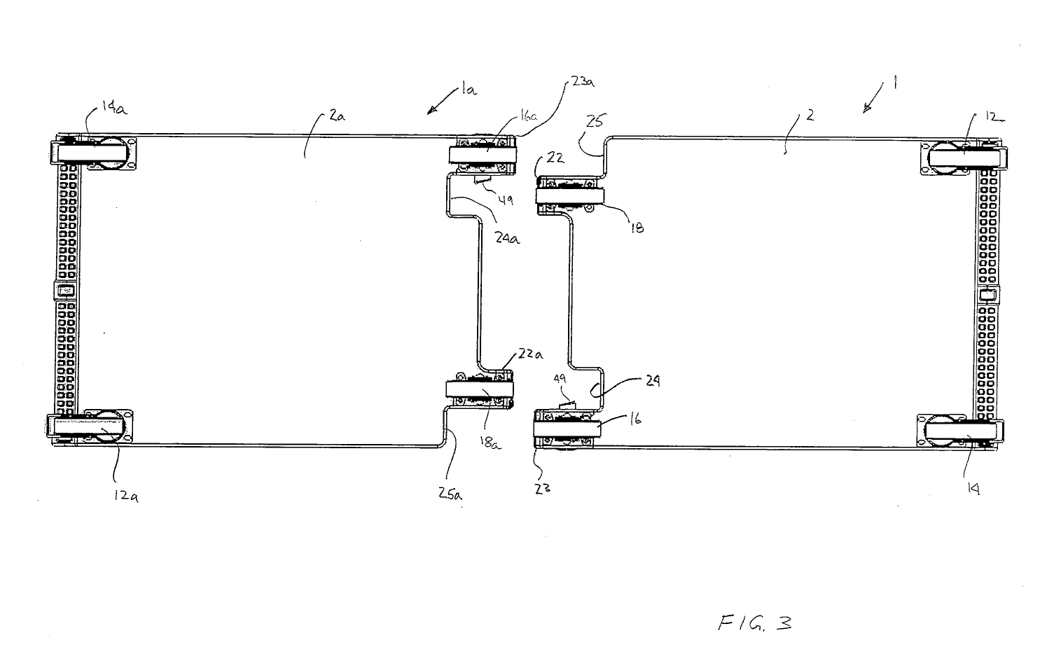

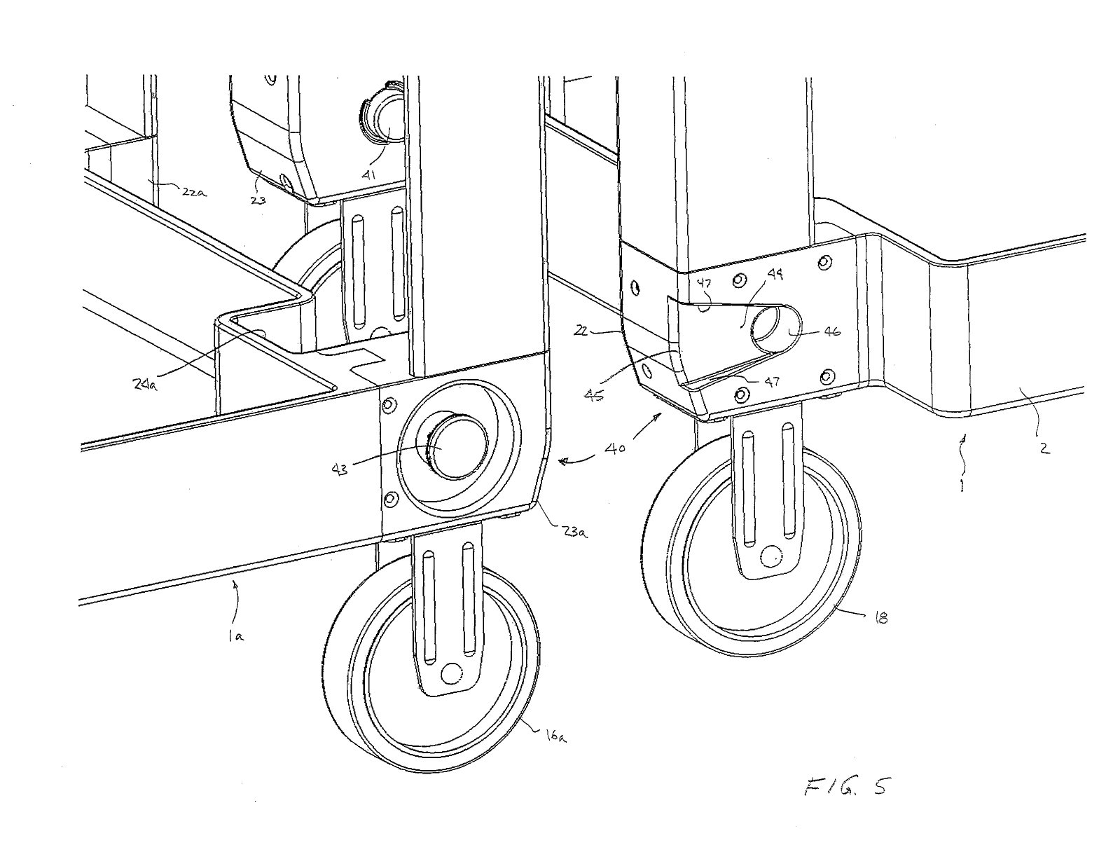

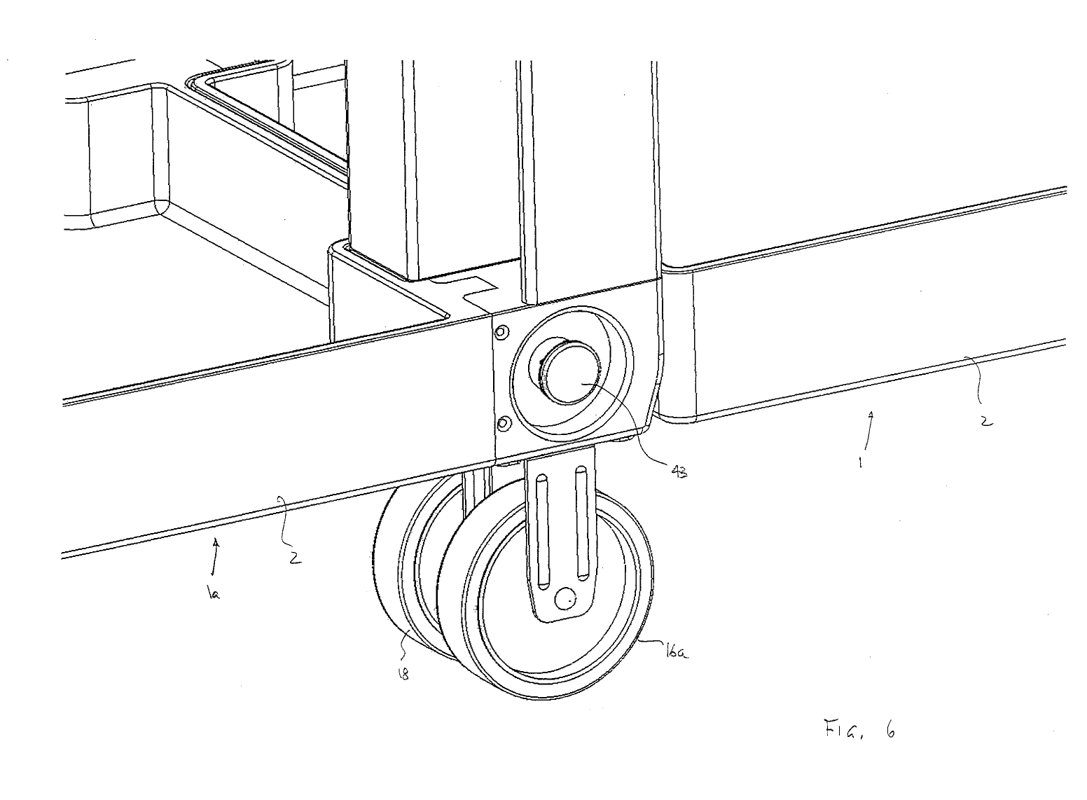

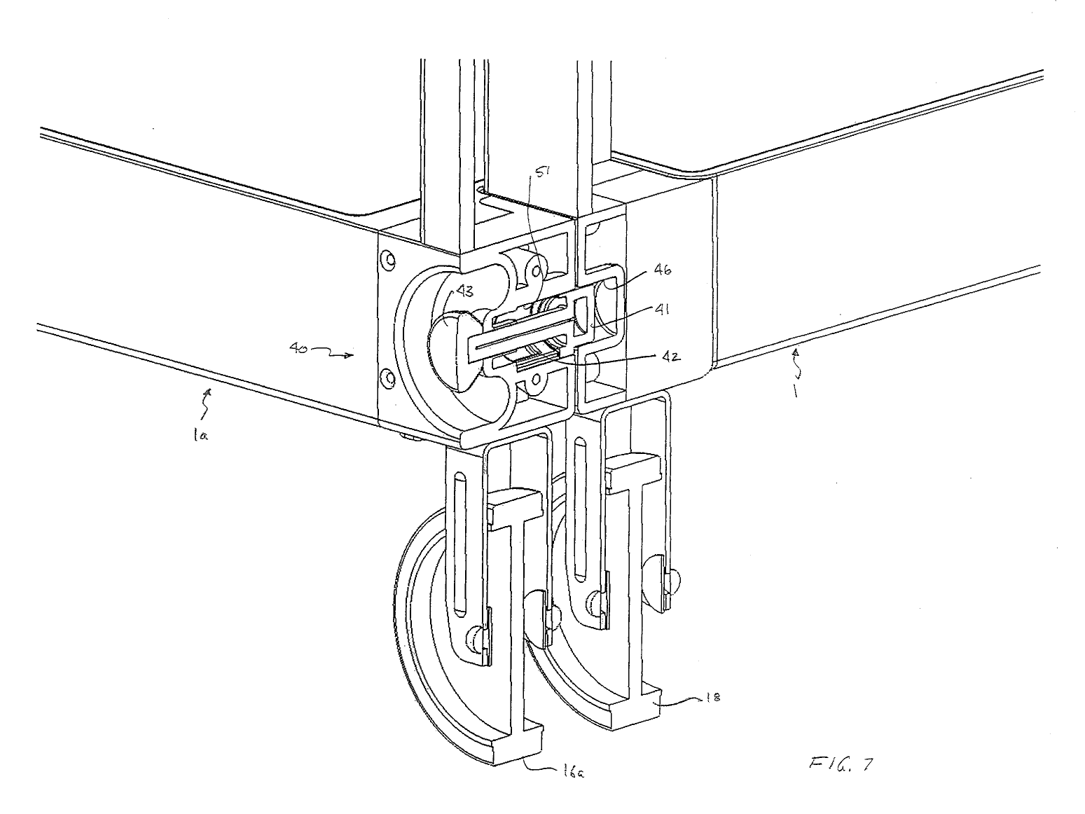

Referring to FIGS. 5, 6 and 7, a lock 40 is used to secure the carts together. The lock 40 includes a latch 41 that is mounted in bore 51 to move transversely to the length of the cart and is biased by spring 42 so as to extend from the side wall of the protuberances 22 and 23. An external knob 43 can be manually grasped to pull the latch against the spring to retract the latch into the cart. The opposing side wall of the mating protuberance includes a camming surface 44 that is angled such that as the carts are pushed together from the position shown in FIG. 1 to the position shown in FIG. 2 the camming surface 44 engages the extended latch 41 and forces the latch 41 to the retracted position. The camming surface 44 has a wide mouth 45 and side walls 47 that taper to hole 46 to facilitate the insertion of the latch 41 onto the camming surface and towards the hole 46. The latch 41 may be formed with a beveled distal end 49 (FIG. 3) that facilitates the engagement of camming surface 44 with the latch 41 as the carts are pushed together. When the retracted latch 41 is aligned with hole 46, spring 42 forces latch 41 to the extended position where it engages hole 46 to lock the carts relative to one another. To uncouple the carts, the user pulls on the knob 43 to retract the latch 41 and remove it from hole 46. Two such locks 40 are shown in the illustrated embodiment although a greater or fewer number may be used. The locks 40 can be uncoupled and coupled to allow the carts to be selectively connected and disconnected by the user. In the illustrated embodiment a lock 40 is associated with each mating protuberance/recess pair of docking system 20 although the locks may be located elsewhere on the carts.

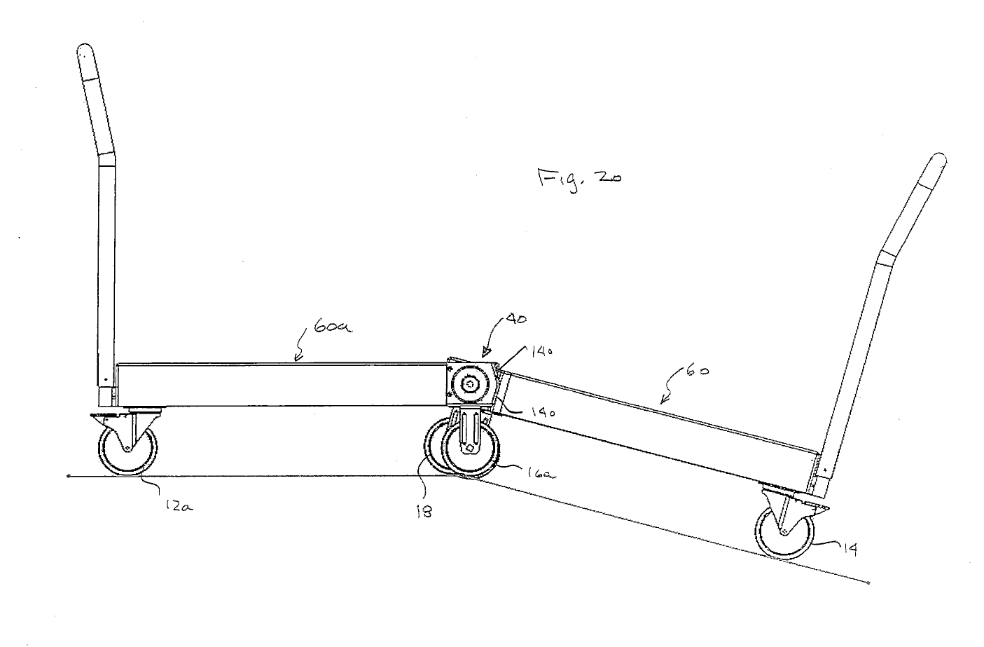

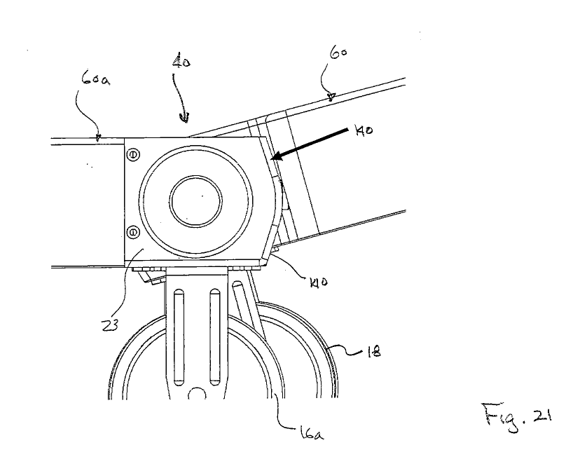

Referring to FIGS. 20 and 21, the docking system and lock of the invention allow the coupled carts to flex about the axis of the lock facilitate the movement of the cart over uneven terrain while minimizing stresses on the system. By making the latch 41 and hole 46 circular in cross-section, these elements can pivot relative to one another to allow the two coupled carts to flex as shown in FIGS. 20 and 21. The end surfaces of protrusions 22 and 23 are angled as shown at 140 to allow the carts to pivot relative to one another.

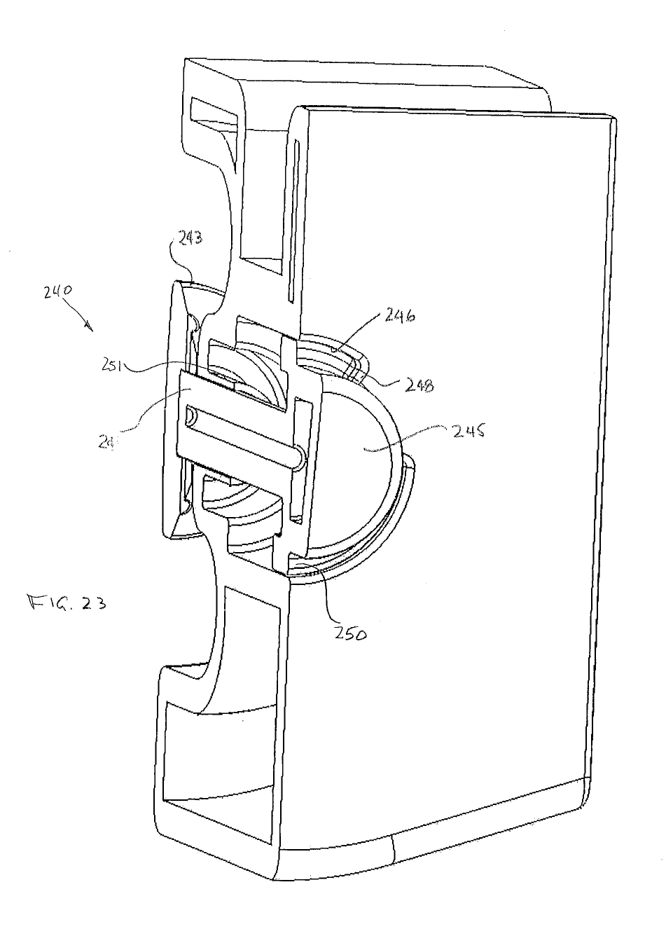

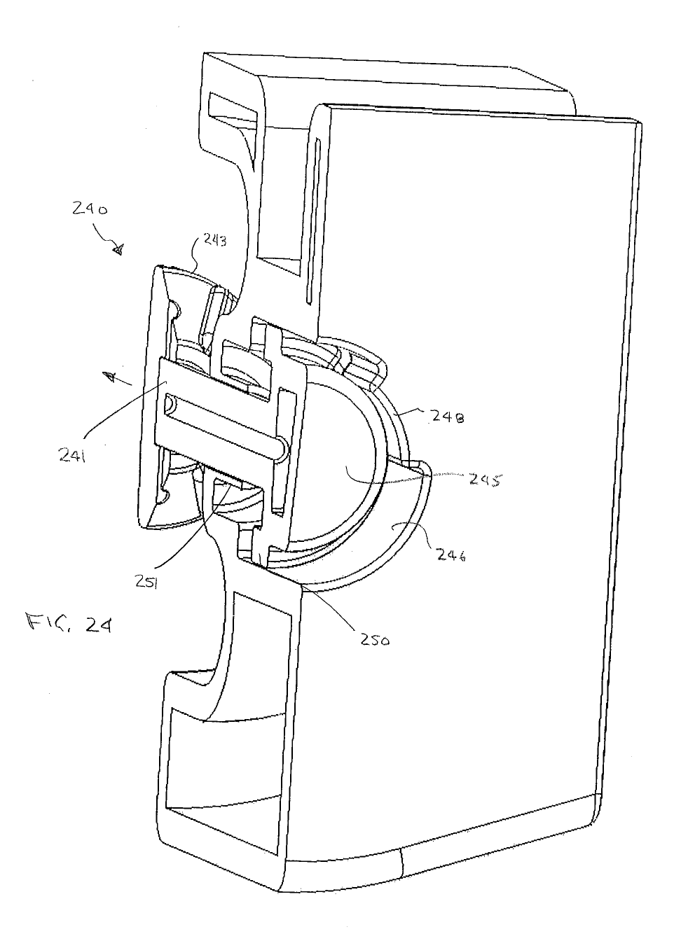

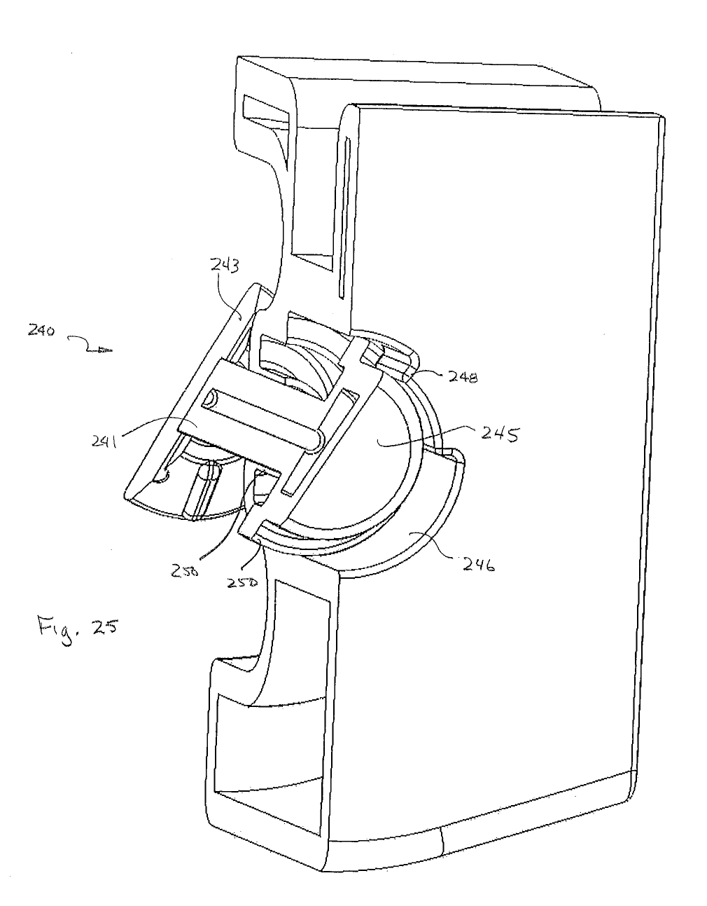

To make the unlocking of the locks and the uncoupling of the carts easier, a lock 240 that may be temporarily held in the unlocked position is provided as shown in FIGS. 23 through 25. The lock 240 includes a latch 241 that is mounted in bore 251 to move transversely to the length of the cart and is biased by spring so as to extend from the side wall of the protuberances 22 and 23 as previously described. An external knob 243 can be manually grasped to pull and rotate the latch 241 against the spring to retract the latch into the cart as will hereinafter be described. The latch 241 includes a head 245 that is inserted into a mating hole 46 on the coupled cart. Head 245 extends through an aperture 246 that has a circular circumference with a projecting flange 248 that extends into aperture 246. Head 245 has an extending flange 250 that is interrupted in the area behind flange 248, flange 250 does not exist in the area behind flange 248 such that a space is created in flange 250 large enough for flange 248 to pass through. When the flange 248 is aligned with the interrupted portion of flange 250, the spring forces the latch 241 to the extended position of FIG. 23. To unlock two carts, the latch 241 is retracted as shown in FIG. 24 by pulling on knob 243. The latch is then rotated as shown in FIG. 25 such that flange 248 overlies flange 250 formed on head 245. In this position the engagement of flange 248 with flange 250 of head 245 prevents the latch from returning to the extended position and reentering hole 46. The second lock is opened in the same manner. The carts can then be separated. Once the carts are separated the latch is rotated back to the aligned position to allow latch 240 to move to the extended position. The mating locks 240 are then positioned to couple the carts together as previously described. Such a system allows the user to open both locks and uncouple the carts without having to unlock both locks simultaneously. Such an arrangement is particularly useful on carts such as the two shelf cart where access to both locks at the same time may be difficult although this arrangement may be used on any cart type.

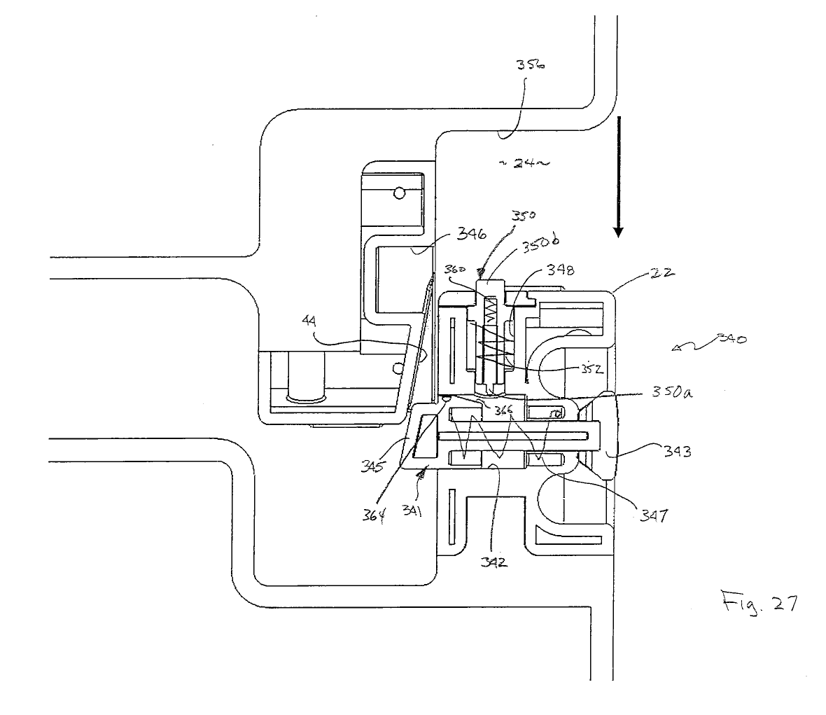

Referring to FIGS. 27 through 30 another embodiment of the locking mechanism of the invention is shown generally at 340. The locking mechanism includes a latch 341 that is mounted in bore 342 to move transversely to the length of the cart and is biased by spring 347 so as to extend from the side wall of the protuberances 22 and 23 as previously described. An external knob 343 can be manually grasped to pull the latch 341 against the spring 347 to retract the latch into the cart as will hereinafter be described. The latch 341 includes a head 345 that is inserted into a mating hole 46 on the coupled cart. Head 345 is angled such that it strikes angled surface 44 when the carts are brought together. The engagement of surface 44 with latch 341 forces latch 341 into the protuberance 22 to the retracted position.

Arranged transversely to bore 342 is a second bore 348 that intersects bore 342. Located in bore 348 is a spring plunger 350 that can reciprocate in bore 348 into engagement with plunger 341. Spring plunger 350 has a first portion 350a that is slidably received in a bore formed in second portion 350b such that the first portion 350a can reciprocate relative to the second portion 350b. A spring 360 biases the first portion 350a away from portion 350b to an extended position. A spring 352 biases the second portion 350b of plunger 350 to the position shown in FIG. 27 where the end of the second portion 350b extends from the protuberance 22.

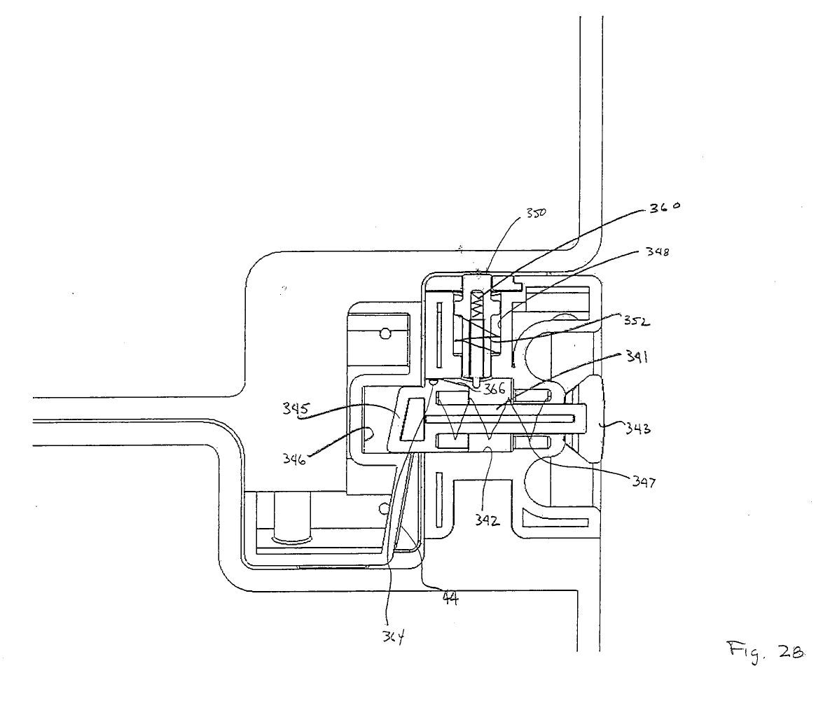

When the carts are pushed together to couple the carts together, the carts move from the position of FIG. 27 to the position of FIG. 28. As the carts move together, latch 341 is partially retracted as it rides over surface 44. Once the latch 341 is aligned with hole 346, spring 347 forces the latch to the extended position such that head 345 engages hole 346 to lock the carts together as shown in FIG. 28. The external end of second portion 350b of plunger 350 contacts surface 356 of recess to move plunger 350 against the bias of spring 352 such that the first portion 350a of plunger 350 extends into bore 342.

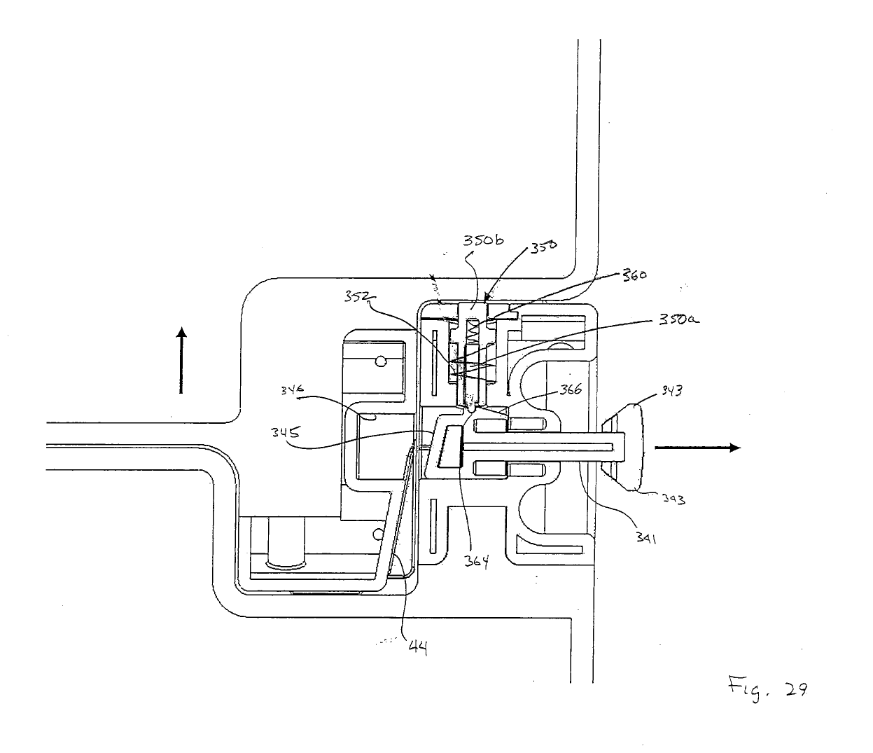

To uncouple the carts, the latch 341 is fully retracted by the user pulling on knob 343 to the position of FIG. 29. In this fully retracted position, the exposed end of first portion 350a extends into a detent 364 formed in latch 341 to hold latch 341 in the retracted, unlocked position shown in FIG. 29. To effect the locking of latch 341, the exposed end of first portion 350a is engaged by cam surface 366 as the latch is manually retracted. First plunger portion 350a is forced by cam surface 366 into second plunger portion 350b against the bias of spring 360. When the detent 364 is aligned with the end of first portion 350a, spring 360 forces the first portion 350a into engagement with detent 364 to lock the latch 341 in the retracted position and out of engagement with hole 346. The unlocking procedure described above is repeated for each lock.

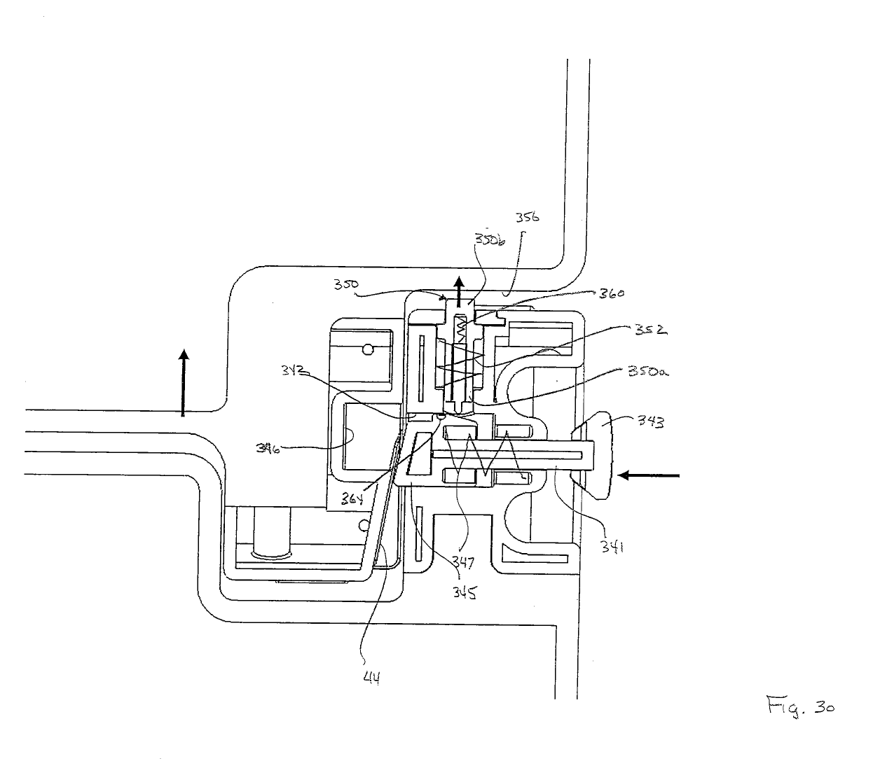

After all of the locks are unlocked, the carts can be uncoupled by pulling them apart as shown in FIG. 30. When the carts are pulled apart, surface 356 of recess 24 is moved out of engagement with plunger 350 allowing plunger 350 to be retracted from detent 364 under the force of spring 352. Latch 341 is then extended to the position shown in FIG. 27 where it is positioned to couple the carts together as previously described. Such a system allows the user to open both locks and uncouple the carts without having to unlock both locks simultaneously. Such an arrangement is particularly useful on carts such as the two shelf cart where access to both locks at the same time may be difficult although this arrangement may be used on any cart type.

In an alternate embodiment the actuator control for retracting the latch 41 is located for example on the cart superstructure 10 such that the user does not have to reach to the bottom of the cart to unlock locks 40. The actuator control can be connected to the latch 41 by a transmission such that manipulation of the control retracts the latch.

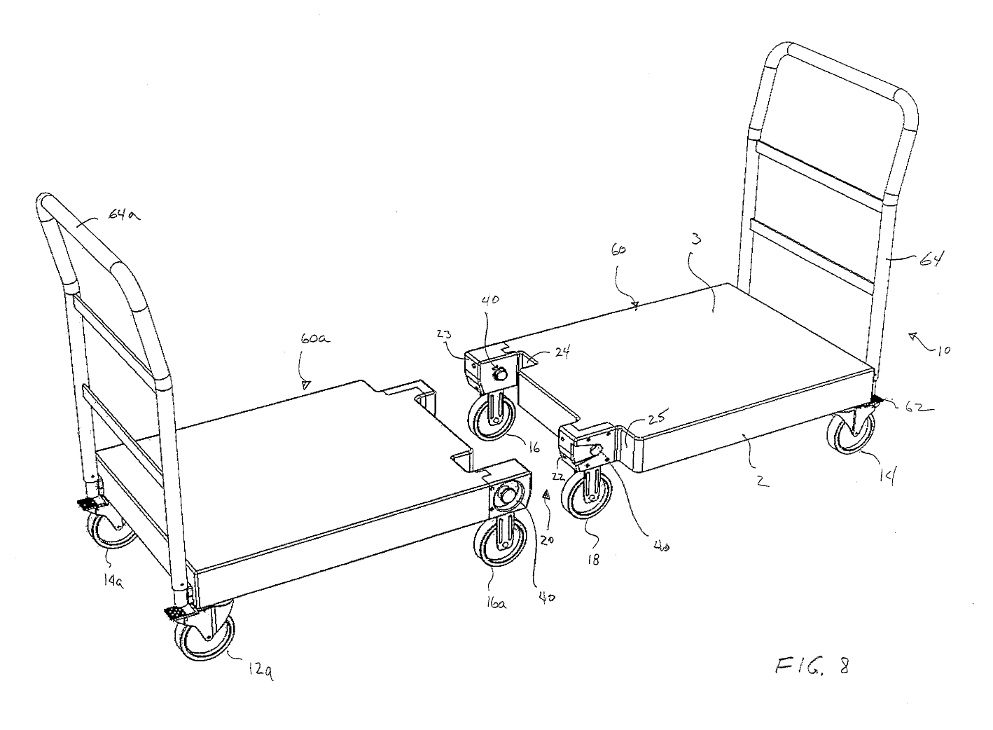

Referring to FIGS. 8 through 10 another embodiment of a cart 60 in accordance with the invention is shown. The cart 60 is a platform truck and includes a base 2 in the form of a platform that is supported on a pair swivel wheels 12 and 14. Located on the second end of the base 2 opposite from swivel wheels 12 and 14 are fixed wheels 16 and 18. The fixed wheel 16 is aligned with swivel wheel 12 along the length of the cart. The fixed wheel 18 is located off-line from swivel wheel 14 along the length of the cart, as previously described. The cart may further include brakes 62 for locking the swivel wheels 12 and 14 in position. The cart includes an upright handle 64 located remote from the docking system 20 as part of superstructure 10.

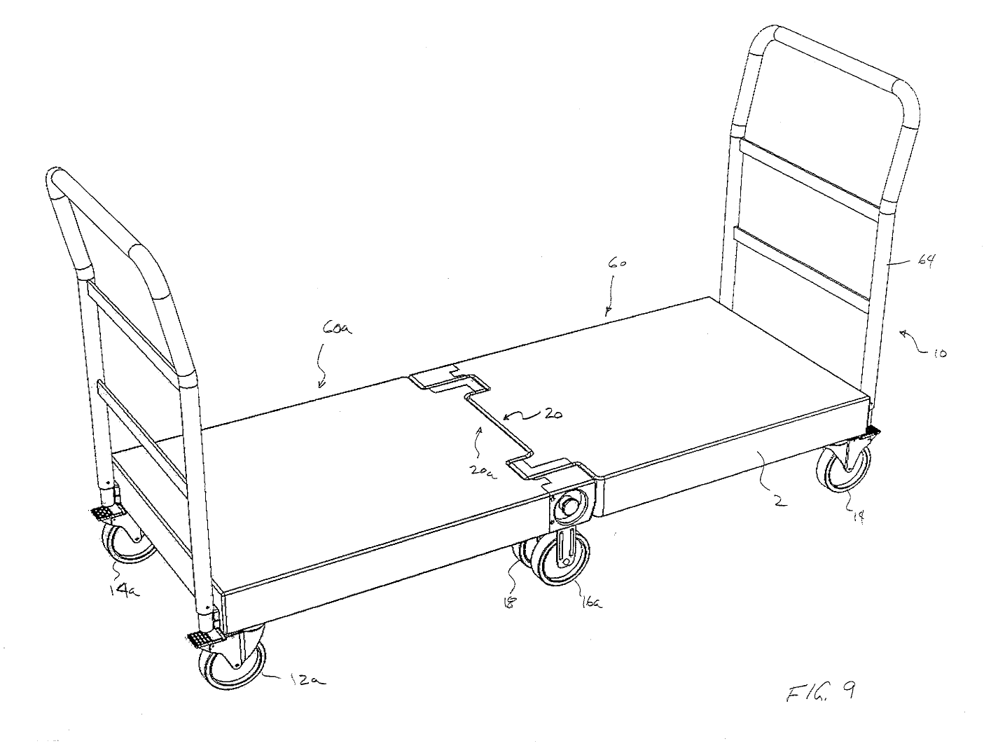

The cart 2 includes a docking system 20 like the docking station 20 described with respect to FIGS. 1 through 4 at the second end of the cart 60 that allows two carts to be joined together. The docking system 20 includes two protuberances 22 and 23 and two recesses 24 and 25 that mate with the same structure on cart 60a to connect the carts together. The wheels fixed 16 and 18 are located on the protuberances 23 and 22, respectively, such that when the carts are connected together (FIG. 9) the protuberances and recesses interlock and the axes of rotation of wheels 16 and 18 on one cart are aligned with the axes of rotation of wheels 16 and 18 on the second cart. Locks 40 are provided to secure the carts to one another as previously described.

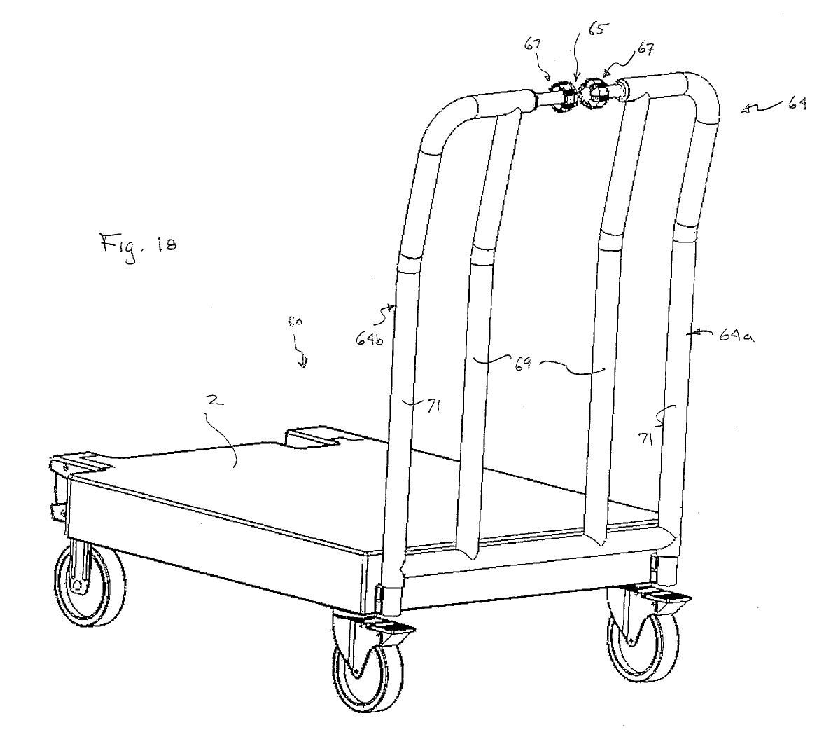

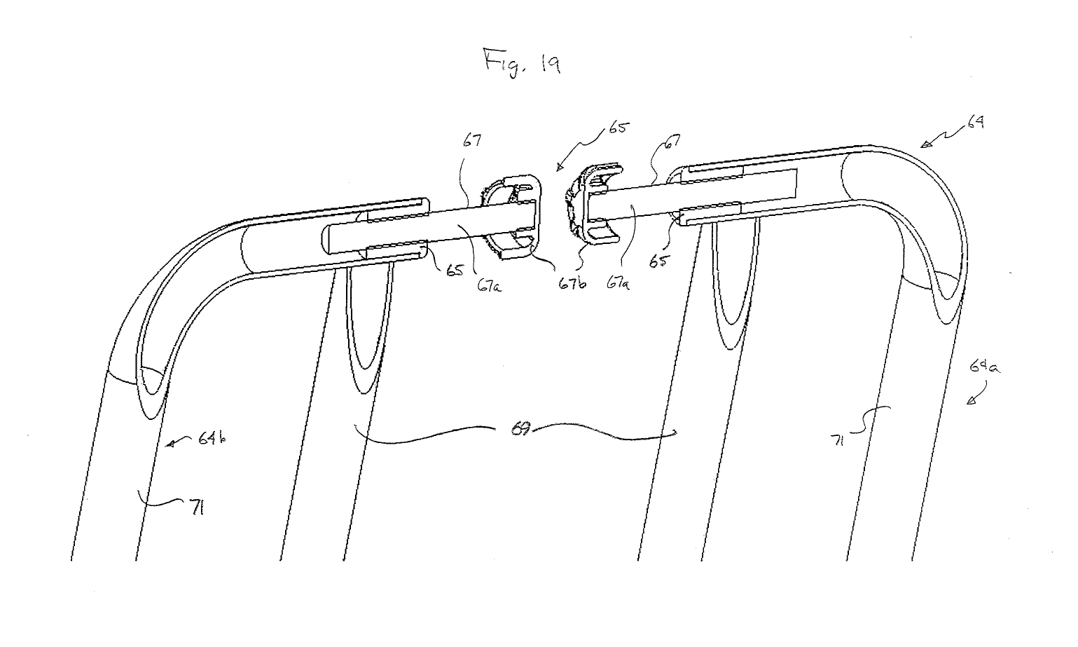

As shown in FIGS. 18 and 19, in one embodiment the handle 64 of cart 60 is formed with a space 65 therein located in the horizontal portion of the handle. Large sheets of material such as wall board can be set vertically on platform 2 and extend into the space 65. Each handle portion 64a and 64b is provided with first vertical support 69 and second vertical support 71. The supports provide structural rigidity to the handle portions and the inner vertical supports 69 support the sides of the material when it is supported in an upright manner. Spindles 67 including screws 67a can be screw thread into threaded bores 65 in the handles such that the spindles can be extended toward one another to clamp the material therebetween. The spindles may include handle portions 67b that can be gripped by the user to rotate the spindles and that contact the material. Further, pegs may be removably inserted in apertures-on the platform to retain the bottom edge of the material to keep the bottom of the material from sliding on the platform. A series of apertures may be provided to allow for adjustability of the distance between the pegs.

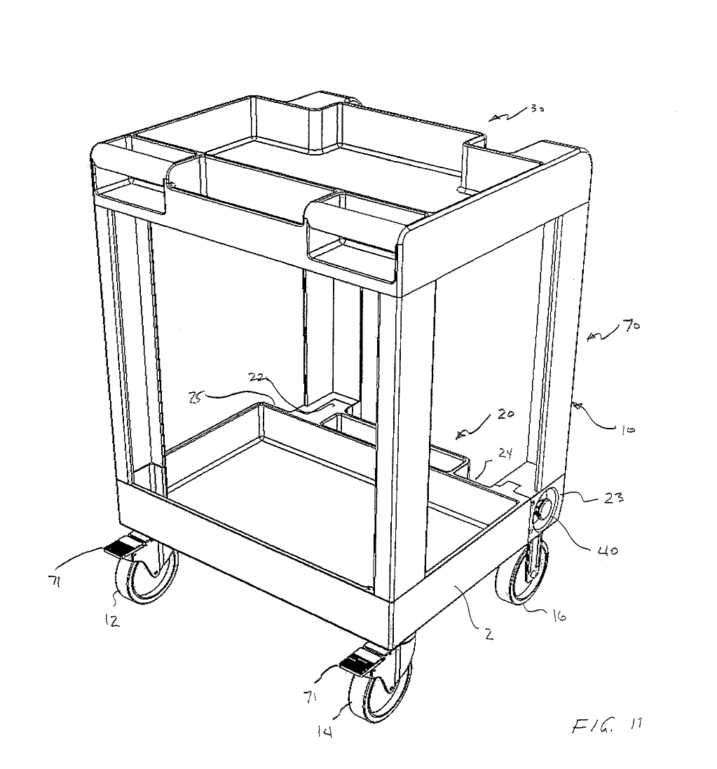

Referring to FIG. 11, an accessory cart 70 is shown that can be attached to any cart configured as previously described to expand the cart's capacity or to provide specialty storage. It is contemplated that the accessory cart 70 will have a shorter length than the carts previously described, however, the specific dimensions of the cart can vary. The accessory cart 70 includes a base 2 that is supported on swivel wheels 12 and 14. Located on the second end of the base 2 opposite from swivel wheel 12 are fixed wheels 16 and 18. The fixed wheel 16 is aligned with the swivel wheel 14. The fixed wheel 18 is located offline from the swivel wheel 12 along the length of the cart, toward the center of the cart, as previously described. The cart includes a superstructure 10 that is intended to receive specialty storage where the storage devices may be made removable from the module such that the storage can be configured and reconfigured as desired by the user.

The accessory cart 70 also includes a docking system 20 at the second end of the cart 2 that allows the cart to be joined to another cart. The docking system 20 includes two protuberances 22 and 23 and two recesses 24 and 25 that mate with one another to connect the carts together as previously described. The fixed wheels 16 and 18 are located on the protuberances 23 and 22, respectively, such that when the carts are connected together the protrusions and recesses interlock. The fixed wheels 16 and 18 are positioned such that when the carts are connected together the axes of rotation of fixed wheels 16 and 18 on the accessory cart 70 are aligned with the axes of rotation of fixed wheels 16 and 18 on the cart to which it is attached. Locks 40 are provided to secure the carts to one another as previously described. The accessory cart 70 also includes an upper docking station 30 as previously described. Brakes 71 may be provided to lock the swivel wheels 12 and 14.

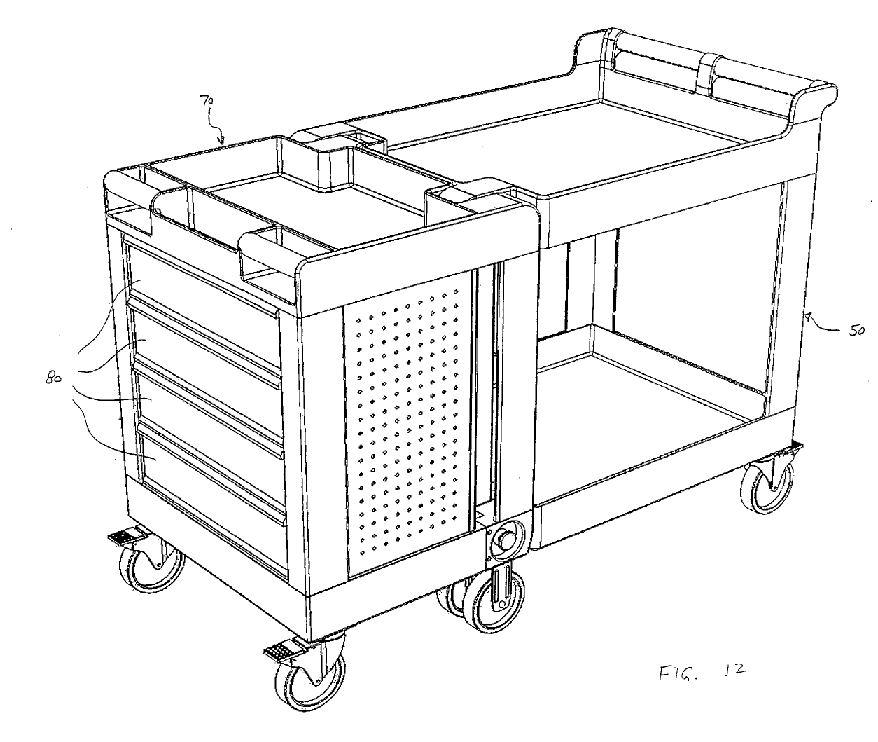

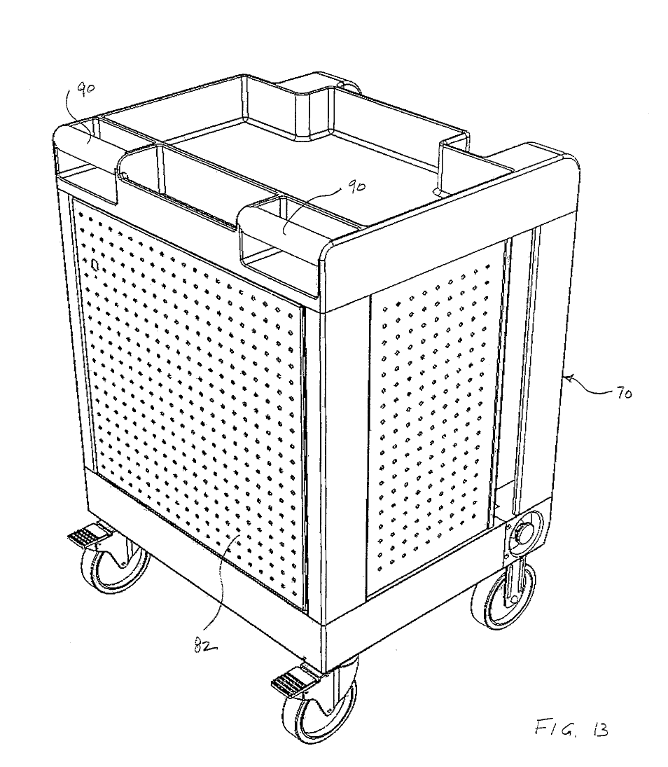

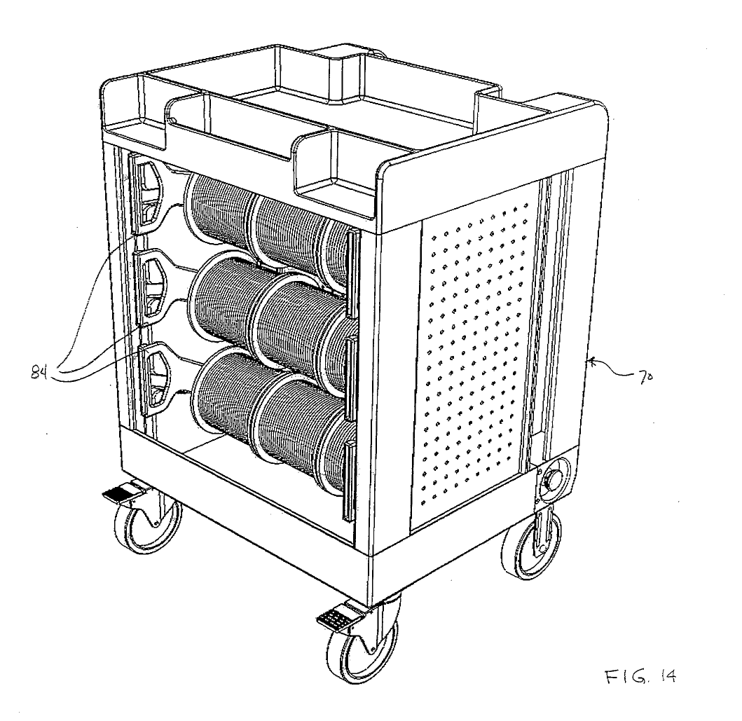

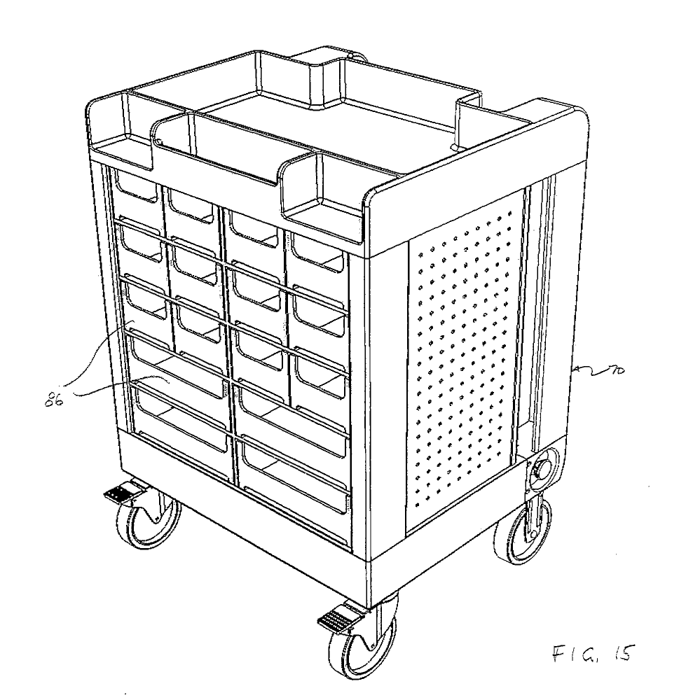

Referring to FIG. 12 the accessory cart 70 may be connected to a second cart such as a two shelf cart 50 and may include sliding drawers 80. Referring to FIG. 13 the accessory cart 70 may include storage cabinet 82. Referring to FIG. 14 the accessory cart 70 may include reel supports 84 for rotatably supporting cable, wiring, rope or the like. Referring to FIG. 15 accessory cart 70 may include a plurality of storage bins 86. Other storage configurations are possible for the accessory cart. Moreover, the accessory cart may support tools such as work benches, table saws or the like.

Different types of carts may be connected to one another where a first type of cart is connected to a second type of cart. In the embodiment shown in FIG. 10, a platform truck 60 is shown connected to a two shelf cart 50 although any configuration or type of cart may be used. In this arrangement the docking system 20 of platform truck 60 is connected to the lower docking system 20a of two shelf cart 50 where the upper docking system 30 is not used. FIG. 12 shows an accessory cart 70 connected to a two shelf cart where both the lower docking systems 20 and upper docking systems 30 are used. Any two types of carts may be connected together provided that one docking system from the first cart is aligned with one docking system from the second cart. A first accessory cart 70 such as shown in FIG. 13 may be connected to a second accessory cart such as shown in FIG. 14 using the docking stations 20 and 30 as previously described. In this embodiment, the accessory cart of FIG. 13 includes handles 90 for pushing or pulling the combined system such that the two accessory carts constitute a complete system.

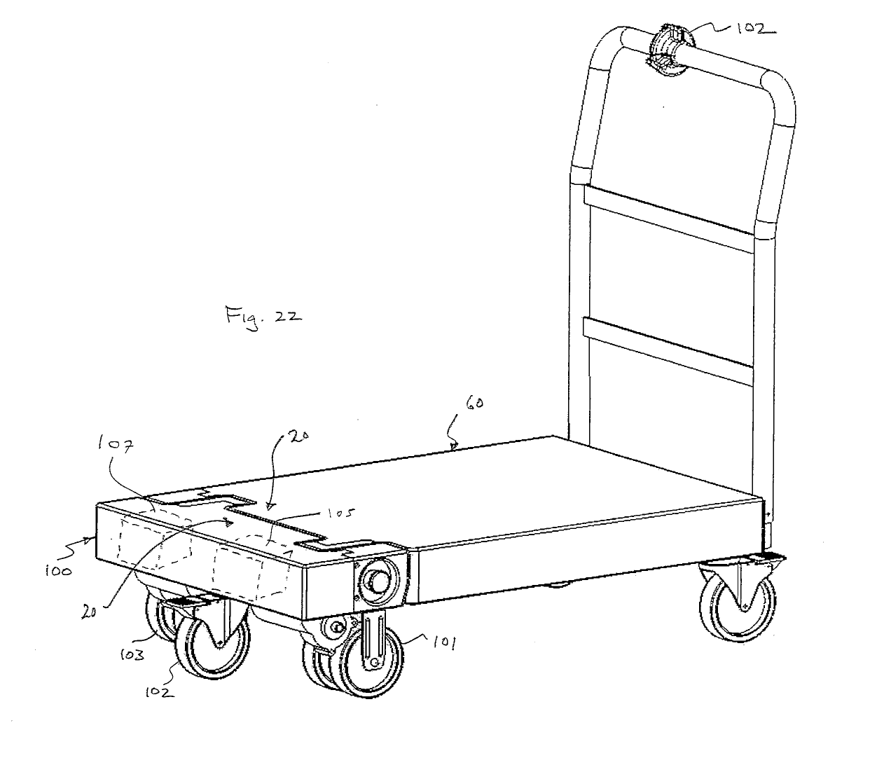

Referring to FIG. 22 a platform truck 60 is shown connected to a motor module 100 using the interlocking docking stations 20 as previously described. The motor module may be connected to any type of cart. The motor module 100 includes wheels 101, 102 and 103 such that the motor module is supported in a stable position. The motor module 100 includes a portable motor 107 driven by a battery 105 that includes a transmission for driving at least one of wheels 101, 102 and/or 103 of the motor module. Other types of motors may also be used. A wireless or wired motor controller 102 may be provided to control the operation of the motor. When the motor module 100 is connected to a cart, operation of the motor module will also drive the cart coupled.

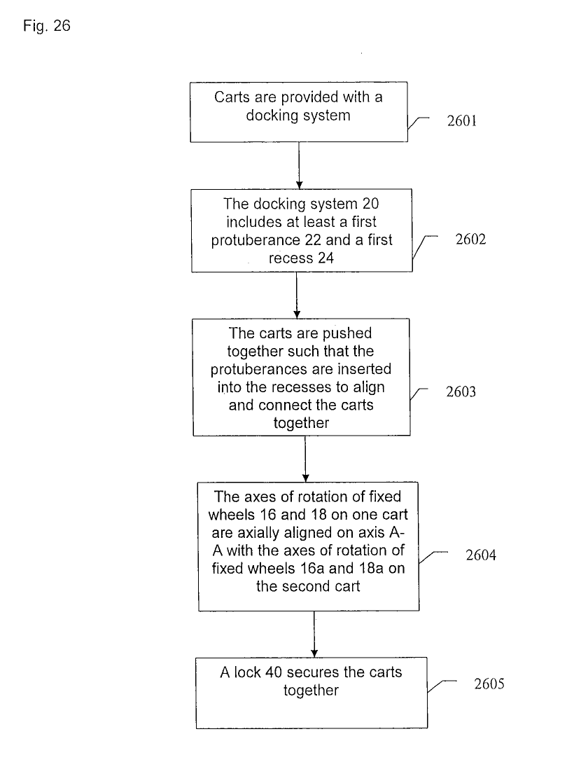

Referring to FIG. 26 to couple the carts together two carts are provided with a docking system 20 (block 2601). The docking system 20 includes at least a first protuberance 22 and a first recess 24 (block 2602). The carts are pushed together such that the protuberances are inserted into the recesses to align and connect the carts together (block 2603). The fixed wheels 16 and 18 are positioned such that when the carts are connected together to create a composite cart, the axes of rotation of fixed wheels 16 and 18 on one cart are axially aligned on axis A-A with the axes of rotation of fixed wheels 16a and 18a on the second cart (block 2604). A lock 40 secures the carts together (block 2605).

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A system comprising:
a first cart comprising a first plurality of wheels and a first docking system;
a second cart comprising a second plurality of wheels and a second docking system for releasably connecting to the first docking system such that said at least one of said first plurality of wheels is axially aligned with at least one of said second plurality of wheels

2. The system of claim 1 wherein said first cart includes a first plurality of swivel wheels.

3. The system of claim 1 wherein said first cart includes a first plurality of fixed wheels.

4. The system of claim 1 wherein said second cart includes a second plurality of swivel wheels.

5. The system of claim 3 wherein said second cart includes a second plurality of fixed wheels.

6. The system of claim 5 wherein when said first docking system is connected to said second docking system said first plurality of fixed wheels is axially aligned with said second plurality of fixed wheels.

7. The system of claim 1 wherein said first docking system includes a first protrusion and said second docking system includes a first receptacle for receiving the first protrusion.

8. The system of claim 1 wherein said second docking system includes a second protrusion and said first docking system includes a second receptacle for receiving the second protrusion.

9. The system of claim 1 wherein one of said first plurality of wheels is located offline from another one of said first plurality of wheels along the length of the cart.

10. The system of claim 1 wherein said first cart comprises a two shelf cart.

11. The system of claim 1 wherein said second cart comprises a two shelf cart.

12. The system of claim 1 wherein said first cart comprises a platform truck.

13. The system of claim 1 wherein said second cart comprises a platform truck.

14. The system of claim 1 wherein said second cart comprises an accessory cart, said accessory cart being configurable.

15. The system of claim 1 wherein said second cart comprises a motor module for driving said first cart.

16. The system of claim 15 wherein said motor module includes at least one driven wheel.

17. The system of claim 1 wherein said first docking system includes a first protrusion and said second docking system includes a second, a fixed wheel being mounted on each protrusion.

18. The system of claim 1 wherein the first cart and second cart are identical.

19. The system of claim 1 wherein the first cart and second cart are asymmetrical.

20. The system of claim 1 wherein the first cart and second cart are symmetrical.

21. The system of claim 1 further including a locking mechanism on each of said first and second carts.

22. The system of claim 1 wherein said locking mechanism allows said carts to flex.

23. A system comprising:
a first cart comprising a first pair of fixed wheels, a first pair of swivel rotating wheels and a first docking system;
a second cart comprising a second pair of fixed wheels, a second pair of swivel wheels and a second docking system for releasably connecting to the first docking system,
said first docking system and said second docking system including mating interlocking elements that connect to one another such that said first pair of fixed wheels is axially aligned with said second pair of fixed wheels.

24. A method of creating a wheeled transport system comprising:
providing a first cart comprising a first plurality of wheels and a first docking system;
providing a second cart comprising a second plurality of wheels and a second docking system;
connecting said second docking system to the first docking system such that said at least one of said first plurality of wheels is axially aligned with at least one of said second plurality of wheels.
